(19) United States
(12) Patent Application Publication
(10) Pub. No.: US 2025/0333033 A1
(43) Pub. Date: Oct. 30, 2025

(54) BUMPER SYSTEM FOR AN AGRICULTURAL MACHINE WHEEL

(71) Applicant: EXEL INDUSTRIES, EPERNAY (FR)

(72) Inventors: Thibault BACLE, LYON (FR); Jocelyn GAUTIER, LYON (FR)

(73) Assignee: EXEL INDUSTRIES, EPERNAY (FR)

(21) Appl. No.: 19/089,136

(22) Filed: Mar. 25, 2025

(30) Foreign Application Priority Data
Apr. 26, 2024 (FR) 2404422

(51) Int. Cl. B60T 7/22; A01B 76/00; B60R 19/18; B60R 19/38

(52) U.S. Cl. CPC B60T 7/22; A01B 76/00; B60R 19/18; B60R 19/38

(57) ABSTRACT

The present invention relates to a bumper system of an agricultural machine, comprising:
a plate pivotably connected to a chassis of the machine, movable between an initial position and a contact position;
a bar movable between an initial position and an activation position;
   the bumper system being configured so that, in the event of the bar coming into contact with an obstacle, the bar moves from its initial position to its activation position, the bar actuating a control member configured to control an emergency sequence of the agricultural machine, the bumper system being further configured so that, in the event of the plate coming into contact with the obstacle, the plate pivots from its initial position to its contact position.

### TECHNICAL FIELD

The present invention relates to the field of agricultural machine, in particular autonomous agricultural machine.

More specifically, the invention is aimed at a bumper system for the wheels of such agricultural machine.

### BACKGROUND

It is known from the state of the art that an agricultural machine, in particular an autonomous agricultural machine, comprises at least one bumper system configured to protect mechanical components of said machine as well as the environment, for example a wheel as well as other components of the drivetrain of the agricultural machine, in the event of collision with an obstacle. Known bumper systems generally have the disadvantage of lacking robustness, particularly due to the duration of an emergency sequence that comprises braking and stopping the vehicle, followed by an evasive maneuver. Indeed, from the moment the collision is detected, and particularly in the case of an autonomous machine, the movement of the agricultural machine may be sufficient to cause the bumper system to break in the best of cases, and sometimes cause the mechanical components protected by the bumper system to break.

To overcome this problem, it has been known to limit the forward speed of agricultural machine, thereby reducing its productivity and efficiency. An agricultural machine is also known to include a sensor for anticipating a collision, for example by means of a LIDAR sensor. Such a solution requires substantial software piloting, and regulatory safety standards are not easily met.

The invention aims to at least partially overcome these disadvantages by offering a bumper system with a significantly reduced risk of damage, providing a better protective function for the mechanical components of an agricultural machine.

### SUMMARY OF THE INVENTION

More specifically, the invention relates to a bumper system for a wheel of an agricultural machine, in particular an autonomous machine, the bumper system comprising:
a skid plate pivotably connected to a chassis of the agricultural machine along a first axis substantially parallel to an axis of rotation of the wheel of the agricultural machine, the skid plate being movable between an initial position wherein the skid plate extends forward and at a distance from the wheel relative to a direction of forward travel of the agricultural machine, and a contact position wherein the skid plate bears against the tire of the wheel;
an activation bar movable between an initial position, wherein the activation bar extends forward and at a distance from the skid plate in relation to the direction of travel of the agricultural machine, and an activation position.

The bumper system is configured so that, in the event of the activation bar coming into contact with an obstacle and the obstacle exerting a force on the activation bar greater than a first threshold, the activation bar moves from its initial position to its activation position, the activation bar in the process actuating a control member configured to control an emergency sequence of the agricultural machine, comprising the braking and automatic stopping of the agricultural machine, the bumper system being further configured so that, in the event of the skid plate coming into contact with the obstacle and the obstacle exerting a force on the skid plate greater than a second threshold, the skid plate pivots about the first axis from its initial position to its contact position

Owing to such a combination of features, such a bumper system enables the activation of an emergency sequence before any contact between the skid plate and an obstacle. In addition, the risk of damage to such a plate or to mechanical components of the agricultural machine, in particular a wheel and the wheel-chassis connection, is significantly reduced, by inducing a pivoting movement of the skid plate in the event of collision with an obstacle before the end of the emergency sequence. In addition, such movement of the skid plate contributes to a progressive application of the contact force of the obstacle on the wheel and to the stopping of the agricultural machine, enabling some of the kinetic energy resulting from the collision to be absorbed.

Advantageously, the activation bar is pivotably connected to the skid plate along a second axis substantially parallel to the axis of rotation of the wheel, the control member comprising a cam, a roller and a switch, the cam being integral with the activation bar, and configured so that, when the activation bar is pivoted from the initial position to the activation position, pivoting the cam causes the roller to move in the direction of the switch so as to trigger the switch to control the emergency sequence of the agricultural machine. In such a configuration, the switch is engaged only when the roller is moved by the cam, that is, when the force exerted by the object on the activation bar is sufficient to rotate the activation bar towards the activation position. In this way, the risk of the emergency sequence being triggered at an untimely moment, for example by vegetation or mud splatter, is significantly reduced.

Advantageously, in the activation position, the activation bar extends at least in part in a position opposite to the direction of travel of the agricultural machine. In such a configuration, the risk of damage to the activation bar in the event of excessive force is significantly reduced, as contact with the obstacle is broken once the first threshold is exceeded.

Advantageously, the bumper system comprises a first return member of the activation bar, the first return member being configured to move the activation bar from its activation position to its initial position. In such a configuration, the activation bar is configured to return to its initial position, in particular after maneuvering the agricultural machine to be clear of the obstacle.

Advantageously, the activation bar is preloaded by means of at least one pin in contact with a stop in the initial position, contact between the pin and the stop being ensured by a return member force equal to the first activation threshold.

Advantageously, the bumper system comprises a second return member for the skid plate, the second return member being configured to pivot the skid plate about the second axis from its contact position to its initial position. In such a configuration, the skid plate is configured to return to its initial position after evasively maneuvering the agricultural machine to be clear of the obstacle.

Advantageously, the skid plate is preloaded by means of at least one chain under mechanical tension between two eyelets in the initial position, one eyelet being integral with the chassis of the agricultural machine and the other eyelet being integral with the skid plate.

Advantageously, the skid plate comprises a rim projecting in a direction opposite to the direction of forward travel, the rim being configured to be in contact with the wheel of the agricultural machine in the skid plate's contact position, the rim further delimiting a housing configured to receive the control member. In such a configuration, the housing accommodating the control unit protects it from the outside environment, and the risk of the control unit being crushed between the skid plate and the agricultural machine wheel is reduced.

Advantageously, the first activation threshold is at least 15 N.

Advantageously, the second activation threshold is between 1 and 40 times the first activation threshold.

Advantageously, the thresholds are adapted so that vertical and/or horizontal accelerations relative to the ground, e.g. due to vibrations or abrupt variations in topography when the agricultural machine is moving forward, are insufficient to displace the activation bar and the skid plate.

According to another aspect of the invention, it relates to an agricultural machine, in particular an autonomous machine, comprising a chassis and a plurality of wheels, each wheel rotating about an axis of rotation so that the agricultural machine moves in a direction of forward travel, the agricultural machine further comprising at least one bumper system as described above, at least partially covering a wheel of the agricultural machine, each bumper system being further configured to control an emergency sequence of the agricultural machine, comprising in particular the braking and automatic stopping of the agricultural machine.

The invention is also aimed at other types of vehicle equipped with the bumper according to the invention as briefly described above, in particular autonomous vehicles such as driverless transport vehicles, also known as AGVs (for Automatic Guided Vehicle), mobile robots, etc.

### BRIEF DESCRIPTION OF THE DRAWINGS

The invention will be better understood upon reading the following description, given by way of example, and referring to the following figures, given as non-limiting examples, wherein identical references are given to similar objects, and wherein:

FIG. 1 is a schematic front isometric perspective view of an agricultural machine wheel fitted with a bumper system according to a first embodiment of the invention;

FIG. 2 is a schematic rear isometric perspective view of the bumper system shown in FIG. 1, in a position for activating an activation bar of said bumper system;

FIG. 3 is a schematic side view of the bumper system shown in FIG. 1;

FIG. 4 is a schematic side view of the bumper system shown in FIG. 1, in an activation position of an activation bar of said bumper system and in a contact position of a skid plate of said bumper system;

It should be noted that the figures set forth the invention in detail to implement the invention; although non-limiting, said figures of course being capable of being used to further define the invention where appropriate.

### DETAILED DESCRIPTION

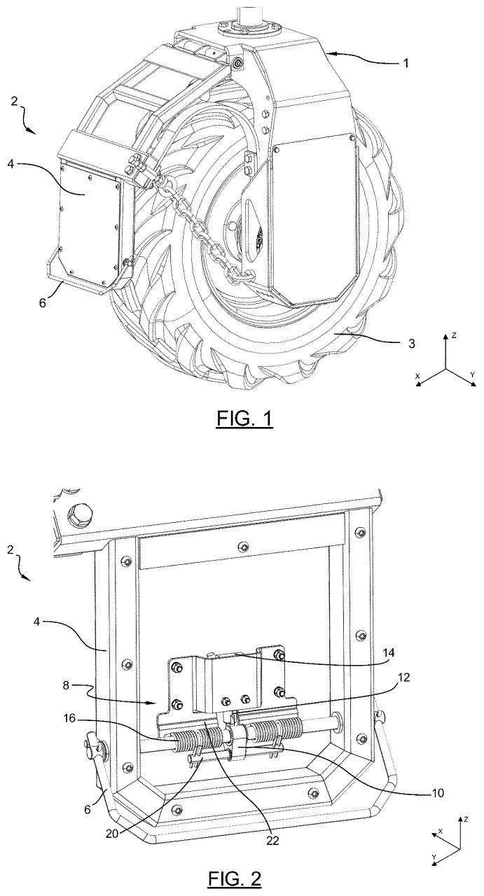

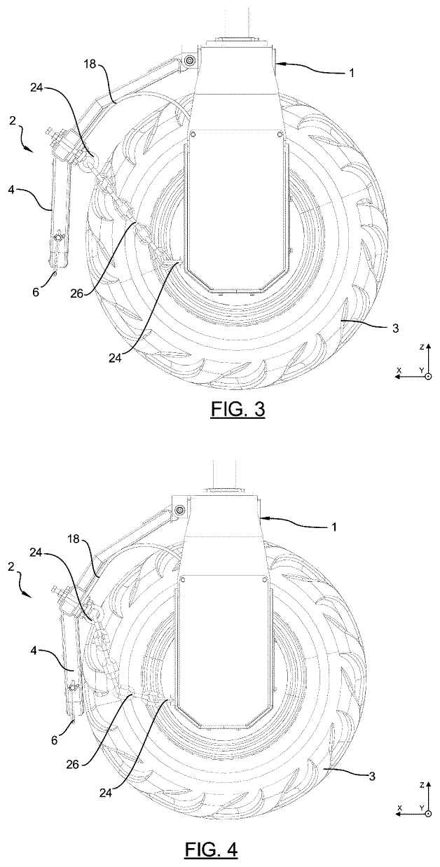

The invention relates in particular to an agricultural machine 1, for example a self-propelled agricultural machine. The agricultural machine 1 is, for example, an autonomous or non-autonomous straddle tractor for plant crops such as vines. The agricultural machine 1 comprises a chassis and a plurality of wheels 3. Each wheel 3 rotates about an axis of rotation substantially parallel to the transverse axis Y as shown in FIG. 1, so as to enable the agricultural machine 3 to move in a forward direction. In FIG. 1, the direction of travel is substantially parallel to the longitudinal axis X. The wheel 3 preferably comprises a tire.

According to another aspect of the invention, at least one wheel 3 of the agricultural machine 1 is at least partially covered by a bumper system 2 as shown in FIG. 1. Preferably, each wheel 3 of the agricultural machine 1 is at least partially covered by a bumper system 2. The bumper system 2 is configured to protect the wheel 3 from the external environment of the agricultural machine 1 and conversely the wheel's environment, for example in the event of collision with an obstacle.

The bumper system 2 thus comprises a skid plate 4 pivotably connected to the chassis of the agricultural machine 1, along a first axis substantially parallel to the axis of rotation of the wheel 3 of the agricultural machine. The skid plate 4 is movable between an initial position, wherein the skid plate 4 extends forward and at a distance from the wheel 3 relative to the direction of travel of the agricultural machine 1, and a contact position, wherein the skid plate 4 bears against the wheel 3 or, where applicable, the tire of the wheel 3.

The bumper system 2 further comprises an activation bar 6 which can be moved between an initial position, wherein the activation bar 6 extends at least partially forward and at a distance from the skid plate 4 relative to the direction of travel of the agricultural machine 1, and an activation position.

In the embodiment shown, particularly in FIG. 2, the activation bar 6 is pivotably connected to the skid plate 4, along a second axis substantially parallel to the axis of rotation of the wheel 3 of the agricultural machine 1. In such a configuration, the activation bar 6 in the activation position has pivoted through a predetermined angle so that the activation bar extends at least orthogonally to the direction of travel of the agricultural machine 1.

Preferably, the activation bar 6 in the activation position has pivoted so that the activation bar extends at least partially in a direction opposite to the direction of travel of the agricultural machine 1. In such a configuration, the activation bar 6 is thus protected from the external environment in the activation position.

The bumper system 2 is configured so that, in the event that the activation bar 6 comes into contact with an obstacle and the obstacle exerts a force on the activation bar 6 greater than a first threshold, the activation bar 6 moves from its initial position to its activation position. In the case where the activation bar 6 is pivotably mounted, said activation bar 6 pivots about the second axis from the initial position to the activation position. In the activation position, the activation bar 6 actuates a control member 8 configured to control an emergency sequence of the agricultural machine 1, particularly comprising the braking and automatic stopping of the agricultural machine 1, as shown in FIG. 2.

The bumper system 2 is further configured so that, in the event that the skid plate 4 comes into contact with the obstacle and the obstacle exerts a force on the skid plate 4 greater than a second threshold, the skid plate 4 pivots about the first axis from its initial position to its contact position, as shown in FIG. 4. In an ideal case, the emergency sequence of the agricultural machine 1 is completed before the skid plate 4 has reached the contact position, thus improving the service life of the bumper system 2.

Preferably, the first activation threshold is at least 15 N, even more preferably above 20 N.

Preferably, the second activation threshold is between 1 and 40 times the first activation threshold

Advantageously, the thresholds are adapted so that vertical and/or horizontal accelerations relative to the ground, e.g. due to vibrations or abrupt variations in topography when the agricultural machine 1 is moving forward or in contact with small vegetation, are insufficient to displace the activation bar 6 and the skid plate 4. In addition, the second threshold can be adapted so that part of the cover plate 4 can support the weight of a user without pivoting, thereby serving as a step. The first threshold is also adapted so that in the event of contact with a person, activation is performed to prevent injury to said person.

Owing to such a combination of features, such a bumper system 2 enables the activation of an emergency sequence before any contact between the skid plate 4 and an obstacle. In addition, the risk of damage to such a plate 4 or to mechanical components of the agricultural machine 1, in particular one of the wheels 3, is significantly reduced, by inducing a pivoting movement of the skid plate 4 in the event of collision with an obstacle before the end of the emergency sequence. In addition, such movement of the skid plate 4 contributes to a progressive application of the contact force of the obstacle on the wheel and to the stopping of the agricultural machine, enabling some of the kinetic energy resulting from the collision to be absorbed. A bumper system 2 of this type does away with the need for sensors such as LIDAR sensors, thus simplifying the addressing of regulatory requirements in the technical field.

Advantageously, if the wheel 3 comprises a tire, the skid plate 4 in the contact position rests on the tire, the stiffness of the tire also contributing to shock absorption and the dissipation of energy from the collision.

The control member 8 advantageously comprises a cam 10, a roller 12 and a switch 14, the cam being integral with the activation bar 6, and configured so that, when the activation bar 6 is pivoted from the initial position to the activation position, a pivoting of the cam 10 causes the roller 12 to move in the direction of the switch 14, so as to trigger the switch 14 to control the launch of the emergency sequence of the agricultural machine. In such a configuration, the switch 14 is engaged only when the roller 12 is moved by the cam 10, that is, when the force exerted by the obstacle on the activation bar 6 is sufficient to rotate the activation bar 6. In this way, the risk of the emergency sequence being triggered at an untimely moment, for example by vegetation, is significantly reduced.

In the embodiment described, the skid plate 4 comprises an edge projecting in a direction opposite to the direction of travel of the agricultural machine 1. The rim is configured to be in contact with the wheel 3 of the agricultural machine 1 in the contact position of the skid plate 4. The rim also delimits a housing configured to receive the control member 8, in this case the cam 10, the roller 12 and the switch 14. The housing accommodating the control member 8 then protects it from the outside environment, and the risk of the control member 8 being crushed between the skid plate 4 and the wheel 3 of the agricultural machine 1, particularly in the contact position of the skid plate 4, is reduced.

The bumper system 2 advantageously comprises a first return member 16 of the activation bar 6, the first return member 16 being configured to move the activation bar 6 from its activation position to its initial position. If the activation bar is pivotably mounted, the first return member 16 is configured to pivot the activation bar 6 from the activation position to its initial position. The first return member 16 is formed, for example, by at least one spring, preferably a torsion spring. In one embodiment, the activation bar 6 is preloaded by means of at least one pin 20 in contact with a stop 22 in the initial position, contact between the pin 20 and the stop 22 being ensured by a force of the first return member 16 equal to the first activation threshold. In such a configuration, the activation bar is configured to return to its initial position, in particular after evasively maneuvering the agricultural machine 1 to be clear of the obstacle.

The term “evasive maneuver” refers to a movement of the agricultural machine in the opposite direction to the initial direction of travel, so that contact between the skid plate 4 and the obstacle that caused the emergency sequence to be initiated is broken. In the case of autonomous agricultural machine, the evasive maneuver is performed automatically, and integrated into the emergency sequence.

Likewise, the bumper system 2 comprises a second return member 18 for the skid plate 4, the second return member 18 being configured to pivot the skid plate 4 about the second axis from its contact position to its initial position. The skid plate is thus configured to return to its initial position, in particular following an evasive maneuver of the agricultural machine 1 to be clear of the obstacle as described above. The second return member 18 is formed, for example, by at least one spring, a torsion spring. The skid plate 4 is preloaded by means of at least one chain 26 under mechanical tension between two eyelets 24 in the initial position, one eyelet being integral with the chassis of the agricultural machine 1 and the other eyelet 24 being integral with the skid plate 4. In the initial position, the mechanical tension of the chain 26 is ensured by a force of the second return member 18 equal to the second activation threshold.

It should also be noted that the invention is not limited to the embodiments described above. Indeed, it will become apparent to the person skilled in the art that various modifications can be made to the above-described embodiments, in the light of the teachings just disclosed.

In the detailed presentation of the invention given above, the terms used should not be interpreted as limiting the invention to the embodiment set out in the present description, but should be construed to include all equivalents the anticipation of which is within the abilities of a person skilled in the art by applying his general knowledge to the implementation of the teaching just disclosed to them.

1. A bumper system for a wheel of an agricultural machine, in particular an autonomous one, the bumper system comprising:
a skid plate pivotably connected to a chassis of the agricultural machine along a first axis substantially parallel to an axis of rotation of the wheel of the agricultural machine, the skid plate being movable between an initial position wherein the skid plate extends forward and at a distance from the wheel relative to a direction of forward travel of the agricultural machine, and a contact position wherein the skid plate bears against the tire of the wheel;
an activation bar movable between an initial position wherein the activation bar extends forward and at a distance from the skid plate relative to the direction of forward travel of the agricultural machine, and an activation position;
the bumper system being configured so that, in the event of the activation bar coming into contact with an obstacle and the obstacle exerting a force on the activation bar greater than a first threshold, the activation bar moves from its initial position to its activation position, the activation bar in the process actuating a control member configured to control an emergency sequence of the agricultural machine, comprising the braking and automatic stopping of the agricultural machine, the bumper system being further configured so that, in the event of the skid plate coming into contact with the obstacle and the obstacle exerting a force on the skid plate greater than a second threshold, the skid plate pivots about the first axis from its initial position to its contact position.

2. The bumper system according to claim 1, wherein the activation bar is pivotably connected to the skid plate along a second axis substantially parallel to the axis of rotation of the wheel, the control member comprising a cam, a roller, and a switch, the cam being integral with the activation bar and configured so that, when the activation bar pivots from the initial position to the activation position, a pivoting of the cam causes the roller to move in the direction of the switch so as to trigger the switch to control the emergency sequence of the agricultural machine.

3. The bumper system according to claim 1, comprising a first return member of the activation bar, the first return member being configured to move the activation bar from its activation position to its initial position.

4. The bumper system according to claim 3, wherein the activation bar is preloaded by means of at least one pin in contact with a stop in the initial position, contact between the pin and the stop being ensured by a force of the return member equal to the first activation threshold.

5. The bumper system according to claim 1, comprising a second return member for the skid plate, the second return member being configured to pivot the skid plate about the first axis from its contact position to its initial position.

6. The bumper system according to claim 5, wherein the skid plate is preloaded by means of at least one chain under mechanical tension between two eyelets in the initial position, one eyelet being integral with the chassis of the agricultural machine 1 and the other eyelet being integral with the skid plate.

7. The bumper system according to claim 1, wherein the skid plate comprises a rim projecting in a direction opposite to the direction of forward travel, the rim being configured to be in contact with the wheel of the agricultural machine in the contact position of the skid plate, the rim further delimiting a housing configured to receive the control member.

8. The bumper system according claim 7, wherein the first activation threshold is at least 15 N.

9. The bumper system according to claim 1, wherein the second activation threshold is between 1 and 40 times the first activation threshold.

10. An agricultural machine comprising a chassis and a plurality of wheels, each wheel rotating about an axis of rotation so that the agricultural machine moves in a forward direction, the agricultural machine further comprising at least one bumper system according to claim 1 at least partially covering a wheel of the agricultural machine, each bumper system being further configured to control an emergency sequence of the agricultural machine, including in particular the braking and automatic stopping of the agricultural machine.

11. The agricultural machine according to claim 10, said agricultural machine being an autonomous machine.
